(19) United States
(12) Patent Application Publication
(10) Pub. No.: US 2024/0024796 A1
(43) Pub. Date: Jan. 25, 2024

(54) CHROMATOGRAPHY WITH IN-LINE EXHAUST

(71) Applicant: Detect-Ion LLC, Tampa, FL (US)

(72) Inventors: Ashish Chaudhary, Odessa, FL (US); Dustin McRae, Tampa, FL (US)

(21) Appl. No.: 18/224,941

(22) Filed: Jul. 21, 2023

Related U.S. Application Data
(60) Provisional application No. 63/369,030, filed on Jul. 21, 2022.

(51) Int. Cl. B01D 15/18; B01D 15/14; B01D 15/16; B01D 15/22

(52) U.S. Cl. CPC B01D 15/18; B01D 15/14; B01D 15/161; B01D 15/22

(57) ABSTRACT

A fluid chromatography device, comprising a first segment of a column configured to connect with an inlet that is configured to receive a fluid sample. The fluid chromatography device includes a second segment of the column in fluid communication with the first segment at a connection and an in-line exhaust in fluid communication with the first segment at the connection between the first and second segments. The in-line exhaust vents the fluid sample from the first segment until closed. The in-line exhaust closes after a period of time after a sample is injected into the first segment. The flow rate of the fluid sample of the first segment before the in-line exhaust closes is higher than a flow rate of the fluid sample of the first and second segments after the in-line exhaust closes.

### TECHNICAL FIELD

This disclosure relates to techniques of controlling a flow rate of a fluid sample in a column used for fluid separation.

### BACKGROUND

Gas chromatography is a technique used to separate target molecules in fluid samples so that a detector can be used downstream to evaluate the individual target molecules of the fluid sample. Generally, a fluid sample is inserted into an injector, and at the injector, the sample is volatilized and mixed with a carrier gas before injection into a column. Along the column, the molecules of the fluid sample separate based on properties of the individual molecules, and each of the target molecules are detectable, if not identifiable, at a detector located at the terminal end of the column.

To achieve good separation, traditional GCs use long columns (e.g., 15-100 m) to allow the molecules of the fluid sample more time to interact with the stationary phase to separate as the fluid sample travels down the long column. However, such long columns utilize undesirable long elution time which may be too long for some applications.

Additionally, sometimes collected fluid samples are relatively small in volume and/or the molecular concentration of the target molecules in the fluidic sample is relatively low. When later mixed with a carrier gas and/or used with a split injector, the target molecules concentration of the fluid sample bolus reaching the detector in a finite time may be lower than the detection limits of the detector making detection difficult.

Accordingly, what is needed are alterative techniques to reduce the time necessary to achieve adequate separation. What is needed are techniques that can retain more target molecules of the fluid sample so that more molecules reach the detector leading to an overall increase in system level sensitivity. What is needed are techniques that can achieve these goals in a miniaturized device.

### SUMMARY

Disclosed herein are implementations of a fluid chromatography device.

In one implementation, a fluid chromatography device includes a first segment of a column that connects with an entry location that receives a fluid sample. The fluid chromatography device includes a second segment of the column in fluid communication with the first segment at a connection and an in-line exhaust in fluid communication with the first segment at the connection between the first and second segments. The in-line exhaust vents the fluid sample from the first segment until closed, and the in-line exhaust closes after a period of time after a sample is injected into the first segment. A flow rate of the fluid sample of the first segment before the in-line exhaust closes is higher than a flow rate of the fluid sample of the first and second segments after the in-line exhaust closes.

In some implementations, the fluid chromatograph device may include a temperature control device that lowers the temperature of the first segment so that the interaction of the molecules with the stationary phase may be enhanced thereby resulting in better separation in the column. The fluid chromatography device may include an entry location in fluid communication with the first segment that receives the fluid sample before injection into the first segment. The fluid chromatography device may include an injection exhaust in fluid communication with the entry location and the injection exhaust vents the fluid sample as the fluid sample is injected into the first segment so that a flow rate of the fluid sample into the first segment is controlled. The entry location may concentrate the fluid sample before entry into the first segment. The fluid chromatography device includes a third segment in fluid communication with the in-line exhaust, the second segment, and the first segment at the connection. The fluid chromatography device may include a detector in fluid communication with second segment that detects molecules of the fluid sample after the fluid sample has moved through the column. The entry pathway may be an injection port, a volatile organic compound pre-concentrator, or a direct air sampler etc.

In another implementation, a fluid chromatography device includes an inlet that receives a fluid sample; and a column that extends between the inlet and an outlet and includes a first segment connected with the inlet and a second segment that is in fluid communication with the first segment and configured to connect with a detector at the outlet. The fluid chromatography device includes an in-line exhaust configured to vent the fluid sample from the first segment until closed, and after the in-line exhaust closes, the fluid flow rate of the fluid sample decreases in the column.

In some implementations, the fluid sample may flow at a first flow rate through the first segment when the in-line exhaust is opened, and the fluid sample may flow at second flow rate when the in-line exhaust is closed. The first flow rate may be greater than the second flow rate. The fluid chromatography device may include an entry location in fluid communication with the first segment and configured to receive the fluid sample and an injection exhaust in fluid communication with the first segment and configured to vent the fluid samples so that the first and/or second flow rate is controlled. The fluid chromatography device may include a temperature control device that adjusts a temperature of the stationary phase of the column. The temperature control device may cool the temperature of the column and control the interaction of the stationary phase. The detector may include a mass spectrometer, a flame ionization detector, a photoionization detector, electron capture detector, ion mobility spectrometer, thermal iconic detector, ultraviolet detector, fluorescence detector, thermal conductivity detector, flame photometric detectors, or any combination thereof.

In another implementation, disclosed is a method that includes injecting a fluid sample into a first segment of a column that is open to an external environment through an in-line exhaust at a first flow rate and closing the in-line exhaust to change the flow rate of the fluid sample to a second flow rate that is less than the first flow rate. The method includes detecting one or more molecules of the fluid sample after the one or more molecules have moved through the column.

In some implementations, the method may include before injecting the fluid sample into the first segment, injecting the sample into an entry location that is in fluid communication with the first segment and an injection exhaust, and the injection exhaust may control the first flow rate. After injecting the fluid sample into the first segment, the method may include closing the first segment from the injection port or pre-concentrator. The method may include cooling the first segment before, while, or after injecting the fluid sample into the first segment. The first segment and the second segment may connect at a connection, and wherein the in-line exhaust connects to the connection through a third segment. The method may include opening the in-line exhaust to vent the fluid sample, after detecting one or more compounds at the detector. The method may include while, before or after opening the in-line exhaust to vent the fluid sample, applying heat to the column.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 illustrates a gas chromatography device.

FIG. 2 illustrates a technique to separate molecules using gas chromatography techniques.

FIG. 3A illustrates results of a Gas Chromatography Mass Spectrometer analysis of a fluid sample an in-line exhaust that is inactive.

FIG. 3B illustrates results of a Gas Chromatography Mass Spectrometer analysis of a fluid sample with an in-line exhaust that is active.

FIG. 4A illustrates results of a Gas Chromatography Mass Spectrometer analysis of a fluid sample with an in-line exhaust that is inactive.

FIG. 4B illustrates results of a Gas Chromatography Mass Spectrometer analysis of a fluid sample with an in-line exhaust that is active.

### DETAILED DESCRIPTION

While the disclosure has been described in connection with certain embodiments, it is to be understood that the disclosure is not to be limited to the disclosed embodiments and is intended to cover various modifications and equivalent arrangements included within the scope of the appended claims, which scope is to be accorded the broadest interpretation to encompass all such modifications and equivalent structures as is permitted under the law.

Volatile organic compounds include organic molecules with a boiling point of about 50° C. to about 250° C. Absorbed in the context of this disclosure mean collected, transferred, on column focused, and/or loaded. One or more as used herein means that at least one, or more than one, of the recited components may be used as disclosed. Substantially or substantial as used herein means that greater than 90 percent of the referenced parameter, composition, structure or compound meet the defined criteria, greater than 95 percent, greater than 99 percent of the referenced parameter, composition or compound meet the defined criteria, or greater than 99.5 percent of the referenced parameter, composition or compound meet the defined criteria. Substantially or essentially free as used herein means that the reference parameter, composition, structure, or compound contains about 10 percent or less, about 5 percent or less, about 1 percent or less, about 0.5 percent or less, or about 0.1 percent or less. Portion as used herein means less than the full amount or quantity of the component in the composition, stream, or both.

The present disclosure provides for a fluid chromatography device that increases system level sensitivity and improves separation of target molecules along the column. Fluid samples are injected into the fluid chromatography device at a first segment which is in fluid communication with an open in-line exhaust and a first segment at a connection. The second segment connects with a detector at a terminal end of the second segment. By including an open in-line exhaust in fluid communication with the first segment during fluid sample injection, a fluid sample travels through the first segment at a high fluid rate, and, therefore, a higher mass of the target molecules in the fluid sample is injected into the first segment and travels towards the open in-line exhaust and the second segment.

Once sufficient fluid sample is injected into first segment, the in-line exhaust is closed so that the fluid sample travels through first and second segments at a flow rate suitable for fluid chromatography. The fluid sample then begins to through the first and second segments fluid flow rate suitable for fluid chromatography. At the reduced fluid flow rate in the column and high mass of the fluid sample from the initial injection into the column while the in-line exhaust was open, the fluid sample moves through the column, begins to separate along the second segment, and is detected at the detector located at the terminal end of the second segment.

The fluid chromatography device may be equipped with an entry location that is configured to receive a sample before injection into the first segment. The entry location may have any size or configuration sufficient to receive a fluid sample and/or preparing a fluid sample for injection into the first segment of the column. Receiving the fluid sample at the entry location may be conducted by any means sufficient to deposit a sample without undesirable contamination. For example, a syringe may be used to receive the fluid sample in the entry location. A fluid sample may be added dropwise in the entry location.

The entry location may be equipped with one or more pathways for mixing carrier gases with the fluid sample before injection into the column. The carrier gas may be any gas at ambient temperature that is inert and sufficient to carry volatile organic compounds through the first and second segments. The carrier gas may be free or essentially free of moisture and/or volatile organic compounds that may negatively impact detection before injection into the column. The carrier gas may include one or more of hydrogen, helium, nitrogen, air that is dehumidified and scrubbed of volatile organic compounds, or any combination thereof. The carrier gas may be received in the entry location at any flow rate sufficient to mix with the fluid sample and inject into the first segment. The carrier gas may be received in the entry location at a flow rate sufficient to provide sharp injection into the first segment. The carrier gas may be received in the entry location at a flow rate sufficient to force the fluid sample through the first segment to the open in-line exhaust. For example, the carrier gas may be received in the entry location at flow rate of about 1 ml/min to about 100 ml/min.

The entry location may include equipment sufficient to volatilize at least a portion of the fluid sample and/or mixture of fluid sample and carrier gas. The equipment may apply heat in a temperature of about 100° C. to about 450° C. The equipment may apply heat for any period of time sufficient to volatilize the fluid sample and/or mix with the carrier gas. For example, the equipment may apply heat for a period of time of about 0.25 seconds to about 120 seconds. In some examples, no entry location is included, and a prepared fluid sample is directly injected into the first location and immediately volatilized upon entry.

The entry location may function to receive a fluid sample before injection into the first segment. The entry location may have any configuration sufficient to receive a sample and/or prepare the sample before injection. The entry location may include an injection exhaust that is configured to vent a portion of the fluid sample and/or a carrier gas so that optimal fluid flow rate is achieved during injection into the column. The entry location may be configured as an injection port that is configured to receive a sample and inject a portion of the fluid sample such that optimal fluid flow rate is achieved and sufficient sensitivity is possible downstream at the detector. In some examples, the entry location may be configured to receive 100 weight percent of a fluid sample and inject a portion of the fluid sample into the column. The portion of the sample that is injected into the column may be any portion sufficient to be detect target molecules downstream. For example, the portion may be about 5 weight percent to about 90 weight percent of the total weight percent of the original fluid sample that is injected into the entry location. For example, the portion of the fluid sample injected into the first segment may be about 90 weight percent or less, about 70 weight percent or less, about 50 weight percent or less, or about 30 weight percent or less of the total weight of the original fluids sample. The entry location may be configured to receive a sample and inject a portion of the fluid sample that is proportional to the injection pressure, internal diameter, and/or volumetric size of the combination of the first segment and the in-line exhaust.

The entry location may be equipped with an injection exhaust that functions to in combination with a temperature control device and/or in-line exhaust control the flow of fluids through the first and/or third segments. The injection exhaust may be positioned anywhere on the entry pathway sufficient to control the fluid flow rate. The injection exhaust may be spaced a distance from the inlet of the first segment sufficient to control the fluid rate at which fluids are injected into the first segment. The injection exhaust may be configured to close before, after, or at the same time as the in-line exhaust. In some examples, the injection exhaust may be configured to vent about 1 percent to about 90 percent by weight of the fluid sample inserted into the entry pathway before injection into the first segment. In some examples, the injection exhaust may be configured to vent fluids sufficient to achieve a fluid rate in the first segment that is about 2 times to about 20 times faster than when fluids flow through the second segment during gas chromatography.

In some examples, the entry location may be configured as a pre-concentrator. Pre-concentration may be an operation as the result of which target molecules are transferred from the sample of larger volume into the sample of smaller volume, so that the concentration of the target molecules is increased. Examples may include a decrease in solvent volume and the transfer of target molecules from one solvent system into another solvent system. In gas chromatography, pre-concentrators may utilize absorption and desorption to increase the concentration of gases and vapors, such as volatile organic compounds. For example, techniques of preconcentration may include absorption of gas molecules at room temperature, desorption of the target molecules at a higher temperature, and subsequent injection into the first segment, which may additionally have optional cooling before receiving another sample.

The column may function to facilitate the separation of molecules in a fluid sample. The column may have any diameter sufficient to receive a fluid sample. The column may have a diameter sufficiently narrow relative to the length of the column to allow the target molecules of the fluid sample to separate along the column. For example, the column may have a diameter of about 10 μm to about 1 mm. The column may have any cross-section sufficient to receive a sample. For example, the column may have a cross-sectional shape of a circle, rectangle, square, oval or some hybrid of these shapes. The diameter may be consistent diameter along the entire length of the column so that consistent fluid flow rate is achieved along the column during different stages of separation. In some examples, the column may include segments that have different diameters or tapered diameters so that different flow rates are achieved during injection compared to fluid chromatography separation.

The column may have any number of segments sufficient to achieve ideal fluid flow during injection and molecular separation. For example, the column may include a first segment configured to receive a fluid sample and a second segment configured to connect with a detector, and the first and second segments are in fluid communication at a connection. In some examples, the column may include a first segment in fluid communication with a second segment and a third segment in fluid communication with an in-line exhaust and the first and second segments so that the fluid flow rate is increased while the in-line exhaust is open. The column may include two or more segments, three or more segments, four or more segments, or a plurality of segment. Additional segments may be included where more than one in-line exhaust is desired in the column.

The total length of the column measured from an inlet of the first segment to the terminal end of a subsequent segment at a location of the detector, which may include any number of segments, such as the first, second, and/or third segment. The total length of the column may be a measure of the sum lengths of all segments in the column. The total length of the column may be measured as a distance between segments that branch from the column, such as when a third segment having an in-line exhaust is included between and extends away from the first and second segments. The column may have a total length sufficient to achieve desirable separation of target molecules in a fluid sample. The column may have a total length sufficient to achieve sufficient flow rates along the column during injection and after the gas chromatography process has begun. For example, the column may have a length of about 1 m to about 100 m.

The column may include a coating sufficient to facilitate movement of volatilized molecules along the column to the detector. The coating may be any suitable material for facilitating gas chromatography separation, such as polydimethyl siloxane, phenylmethyl polysiloxane, trifluoropropylmethyl polysiloxane, cyanopropylphenylmethyl polysiloxane, Squalane, Apezion L, polyethylene glycol, or any combination thereof. The column may include a single coating along the entire length of the column so that uniform properties are achieved along the column. In some examples, the column may include different coatings along different segments so that high concentration samples can be loaded before beginning gas chromatography and/or sufficient fluid flow rate is achieved during different steps.

The first segment functions to receive the fluid sample at an inlet of the first segment. The first segment may have a length sufficient to receive a desirable volume of fluid sample at a desirable concentration of target molecules in the fluid sample. The first and third segments may in combination may be configured to absorb desirable mass of the target molecules by flushing a significant volume of the fluid sample while the in-line exhaust is open. The length of the first segment may be less than a length of the second segment so that a high flow rate is maintained during injection and desirable chromatography conditions are achieved after the in-line exhaust is closed.

The first segment may have a length that is proportional to the second segment such that a large enough sample is received in the first segment and separated in the second segment such that targeted molecules are detectable at the detection device position on a terminal end of the second segment. The first segment may have a length sufficient to receive the fluid sample and to maintain sufficient fluid flow rate during injection to absorb a desired mass of target molecule sand, after the in-line exhaust is closed, a flow rate sufficient for gas chromatography is established. By having a shorter first segment than a second segment, flow rate resistance is minimized and desirable high flow rates can be achieved to flush larger volumes of fluid sample. For example, the first segment may have a length of about 0.1 cm to about 50 cm.

The first segment may have a coating thickness sufficient to achieve desirable absorption of target molecules as the fluid sample is injected into the first segment. The thickness of the coating in the first segment may be thicker in the first segment than the second segment such that desirable injection mass is absorbed in the first segment. For example, the coating may have a thickness of about 0.1 μm to about 5 μm.

The length and/or diameter of the first segment may be sufficiently large to maintain a high fluid flow rate as a sample is inserted into the column. The length and/or diameter may be the same or different than the second and/or third segments so that fluid flow rate is controlled during injection into the first segment and after beginning the gas chromatography separation process. For example, the first segment may have a diameter of about 100 μm to about 1000 μm. The fluid flow rate in the first and/or third segments may be higher during injection than when the in-line exhaust is closed. In some examples, the fluid flow rate in the first and/or third segments may be between about 2 and 20 times larger during injection than when the in-line exhaust is closed. By achieving a high fluid flow rate during injection, a large volume of fluid sample can be injected in the first segment, and once sufficient mass of the target molecules from fluid sample is absorbed within the first and/or third segment, the in-line exhaust is closed and fluid sample moves through the column at a fluid rate that is sufficient for gas chromatography. In some examples, the fluid flow rate in the first and/or third segments during injection may be about 5 ml/min to about 100 ml/min. The fluid flow rate may be controlled or influenced by the inclusion of an injection exhaust positioned at the entry location.

During injection, the in-line exhaust is open as described herein so that a high fluid rate is achieved. The in-line exhaust functions to increase fluid rate within the first segment such that sufficient volume of fluid sample is injectable within the first segment in a short time so that a desirable mass of target molecules is absorbed in the first and/or third segments. For example, the in-line exhaust may be left open for any period of time sufficient to receive a fluid sample within the first segment and to avoid losing a large mass of the fluid sample out of the in-line exhaust. For example, between about 10 weight percent and about 100 weight percent of the target molecules may be absorbed within the first segment after injection. If too much of the fluid sample is lost through other inject means, such as during simple split injection, the fluid sample may not retain detectable masses of the target molecules after injection into the column. The in-line exhaust may be left open for a period of time sufficient to desorb the target molecule before beginning chromatography. In some examples, the in-line exhaust may be left open for a period of about 1 seconds to about 1000 seconds during injection, based on the temperature applied and flow rate achieved within the entry location during injection.

The second segment may be configured to facilitate separation of fluids from the first segment to the detector. The second segment may have a connection at a location of the first segment (i.e., at an in line second segment inlet) and/or at a location of the detector (i.e., at an outlet) to control the flow of fluids into and out of the second segment. The diameter of the second segment may be the smaller, larger or the same as the first segment to control the flow of fluids along the column to the detector. The second segment may have a diameter of about 10 μm to about 1000 μm. The second segment may have any length sufficient to achieve adequate separation of molecules as the molecules move from the first segment to the detector. For example, the second segment may have a length of about 5 m about 100 m. In some examples, the second and first segments may have a length ratio such that fluids can be adequately separated along the column after beginning the process of gas chromatography in the second segment. For example, the second and first columns may have a length ratio of about 250:1 to about 20:1. When an in-line exhaust is closed, the fluid chromatography device is ready to begin a process to separate molecules along the second segment, such as by gas chromatography. Along the second segment or the combination of the first and second segments, the fluid sample may move at a fluid flow rate sufficient to adequately separate along the second segment. The fluid flow rate may be controlled by the temperature control device to adjust movement of molecules along the second segment. For example, the fluid flow rate in the second segment or combination of first and second segments at about 0.1 ml/min to about 5 ml/min. The second segment may have an internal coating that is different in thickness relative to the first segment so that desirable separation is achieved once the gas chromatography process begins. For example, the second segment may have an internal coating thickness of about 0.1 μm to about 5 μm.

The third segment may function to provide a pathway between the in-line exhaust and the connection, first segment, or both. The third segment may be in fluid connection with the connection, the first segment, or both. The connection may be configured to control fluid communication between the first and third segments. The third segment may extend from a surface of the first segment or the connection at any angle sufficient to control the flow of fluids from the first segment. For example, the third segment may extend from an angle of about 45 degrees to about 90 degrees. The third segment may have a length sufficient to control fluid flow rate between the entry pathway and the in-line exhaust along the first segment and/or to hold fluids before beginning gas chromatography separation. The third segment may be shorter, longer, or the same length as the first and/or second segment. In some examples, the third segment is not included and the in-line exhaust is directly integrated with the connection between the first and second pathways. The diameter of the third segment may be any diameter sufficient to assist with fluid flow rate in the column. For example, the third segment may have a diameter that is the same as the first and/or second segments. The third segment may have a diameter that is larger than the first and/or second segments so that fluids flow faster as the fluids move from the first segment to the third segment. In some examples, the third segment may have a diameter of about 10 μm to about 1000 μm. In some examples, the third segment may have a diameter and/or length sufficient to achieve desirable fluid flow out of the third segment as a sample is injected into the first segment. The third segment may include a coating, as described in relation to the column, or may be free of a stationary phase so that fluid samples are more effectively moved through the third segment.

The column may include one or more connections configured to control fluid communication between any of the first, second, third, or other segments. The column may include any number of connections sufficient to facilitate fluid flow between segments during injection or gas chromatography. In some examples, a first connection may be included between the first and third segments and a separate second connection may be position downstream of the first connection between the first and second segments so that fluids can be desirably moved towards the in-line exhaust. A connection or valve may be positioned at an inlet and/or outlet of the column to facilitate or control the flow of fluids into and out of the column. A connection may be positioned at an inlet and/or outlet of the entry location. In some examples, the connection may be integrated with the in-line exhaust such that the connection can simultaneously facilitate the flow of fluids out the in-line exhaust and between the first and second segments. In some examples, the column may include one or more, two or more, three or more, four or more, or a plurality of connections. The connection may have any configuration sufficient to facilitate fluid communication between two or more different segments of the column or into and out of the column. For example, the connection may be configured as a tee and wye fitting, or any combination thereof. In some examples, the connection may be configured as a valve configured to control fluid flow or communication between the first and second segments. For example, the connection may be configured as a solenoid valve, a check valve, a plug valve, a ball valve, a butterfly valve, a slam-shut valve, a globe valve, a gate valve, a latching valve, or any combination thereof.

The fluid chromatography device may be equipped with one or more temperature control device that function to cool and/or heat a fluid sample in the column along first, second, and/or third segment so that fluid flow rate is controlled and sample separation is controlled. The temperature control devices may be configured to provide a cooling effect as a fluid sample is added to the first segment so that during injection a larger mass of molecules is retained within the first segment, which improves sensitivity of the system. The cooling effect may enhance the number of molecules adsorbed in first segment. The temperature control device may be configured as a device sufficient to lower the temperature of stationary phase of the gas chromatography. For example, the temperature control device may be configured as a Peltier cooling stage, heat gun, resistive heating wire bracket, or any combination thereof. The temperature control devices may be configured to apply heat to the column when the in-line exhaust is closed and the gas chromatography is performed so that the separation of molecules along the column is controlled and better separation is achieved at the detector. The temperature control device may be integrated with, contacted with, or spaced a distance from any of the segments of the columns in a manner sufficient to control the temperature of the fluid sample in the column. The fluid sample may be injected into the first segment at a first temperature and the temperature control device may be configured to raise or reduce the temperature of the stationary phase by about 1° C. to about 50° C. so that the fluid flow rate or absorption/desorption in the column is desirably controlled.

The detector functions to detect one or more compounds in the fluid sample after the fluid sample has travelled through the column. The fluid chromatography device may be configured to connect with any detector desirable for fluid sample analysis. The detector may be configured to identify target molecules or peaks within the fluid sample. The detector may be configured to retain the sample, the sample data, or to vent the sample to an external environment. The detector may be a mass spectrometer, a flame ionization detector, a photoionization detector, electron capture detector, ion mobility spectrometer, thermal iconic detector, ultraviolet detector, fluorescence detector, thermal conductivity detector, flame photometric detectors, or any combination thereof.

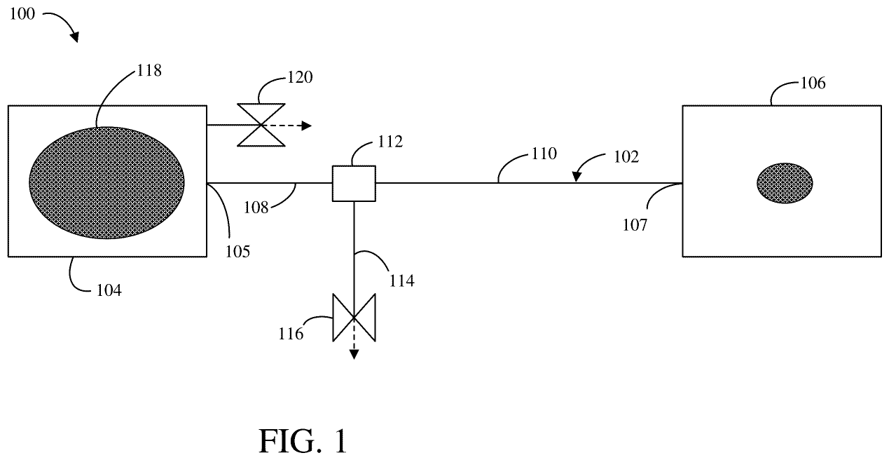

FIG. 1 illustrates a fluid chromatography device 100. The fluid chromatography device 100 includes a column 102 in fluid communication with an entry location 104 at an inlet 105 and a detector 106 at an outlet 107. The column 102 includes a first segment 108 that is in fluid communication with a second segment 110 via a connection 112 that is open between the first and second segments 108, 110. At the connection 112, a third segment 114 is in fluid communication with the first and second segments and an in-line exhaust 116 that is configured to vent fluids as a fluid sample 118 is injected into the column 102. Each of the first, second, and third segments 108, 110, 114 are in fluid communication at the connection 112, and the connection 112 facilitates the flow of fluids between one or more of the first, second, and third segments 108, 110, 114 as the fluid chromatography device 100 operates and whether the in-line exhaust 116 is open or closed.

The entry location 104 includes an injection exhaust 120 used to control the flow rate of the fluid sample 118 as the fluid sample 118 is injected into the column 102. When the fluid sample 118 is injected, a portion of the molecules enter the column 102 and another portion of the molecules exits the entry location 104 via the injection exhaust 120. With this configuration, a relatively large volume of the fluid sample 118 is injected into the entry location 104 and is subsequently injected into the column 102, which has a relatively small cross-sectional area compared to the entry location 104.

During injection, the in-line exhaust 116 is open so that a portion of the fluid sample 118 travels through the first and third segments 108, 114 and out of in-line exhaust 116 at a first flow rate. Once a sufficient period of time has passed, the in-line exhaust is closed, and the fluid sample moves through the first and second segments 108, 110 at a second flow rate, which is less than the first flow rate and suitable for gas chromatography. Because the second flow rate is lower than the first flow rate, the portion of the fluid sample 118 in the first segment 108 moves through second segment 110 towards the detector, and molecules traveling through the second segment 110 begin to separate according to their properties of each molecule. With this configuration, a relatively large volume of fluid sample 118 is injected into the column 108 via the fluid control from the in-line exhaust, and the fluid sample 118 achieves quality separation in the second segment 110 and the fluid sample 118 travels at a reduced flow rate, which accordingly provides for high sensitivity due to a high volume of sample injected in 108 and good separation in the column 102 due to control of fluid flow rate and sufficient interaction with the stationary phase.

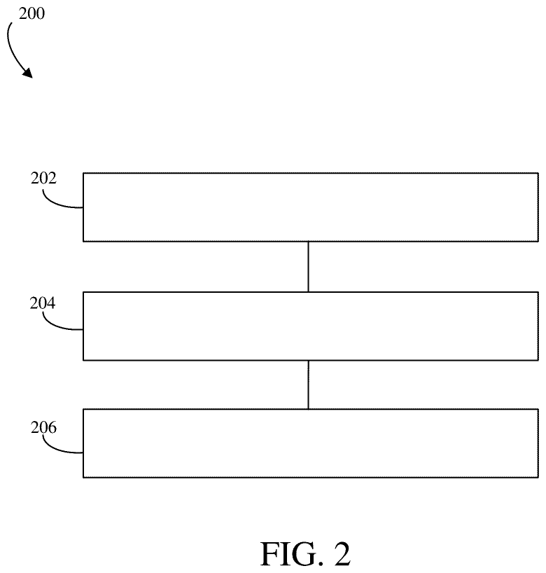

FIG. 2 illustrates a method 200 to separate molecules using fluid chromatography techniques. The method includes injecting 202 a fluid sample into a first segment that is fluid communication with an open in-line exhaust. Optionally, the injecting 202 step may include injecting the fluid sample into a pathway with or without an optional injection exhaust to assist with the fluid flow rate within the first segment. Once a sufficient volume of fluid sample is pushed through the first segment towards the open in-line exhaust at a high fluid flow rate, the method includes a step of closing 204 the in-line exhaust such that fluid flow rates in the first and second segments of the column significantly drop to a fluid flow rate optimal for performance of gas chromatography separation and the molecules of the fluid sample travel down the column to a detector. Before, during, or after the injection of the fluid sample, a temperature may be applied to the column to control the stationary phase such that higher sensitivity is achieved for the target molecules at the detector after separation. After performing the gas chromatography separation, the in-line exhaust may be optionally opened again to expel any remaining fluid sample. At the end of the column, the method includes a step of detecting 206 the sample using a detector so that the user can identify whether target molecules are present in the fluid sample. Optionally, the method may include a step of retaining the fluid sample for later analysis or venting the fluid sample from the column and/or detector so that another fluid sample may be injected into the fluid chromatography device for analysis.

### ILLUSTRATIVE EXAMPLES

The following examples are provided to illustrate the disclosure, but are not intended to limit the scope thereof.

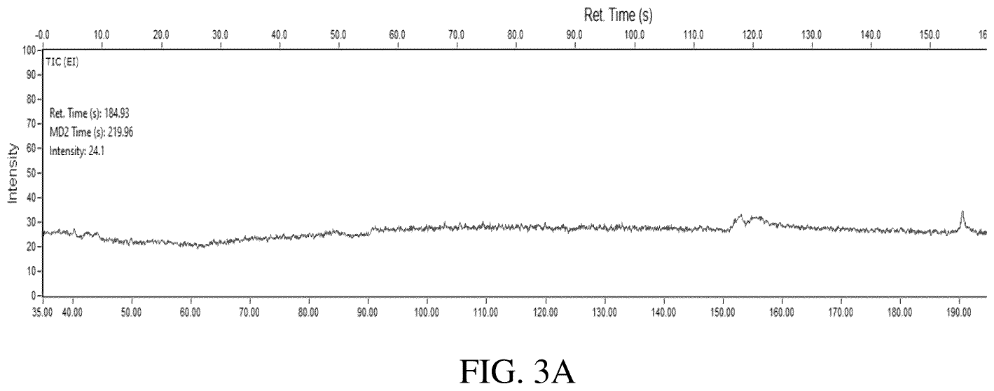

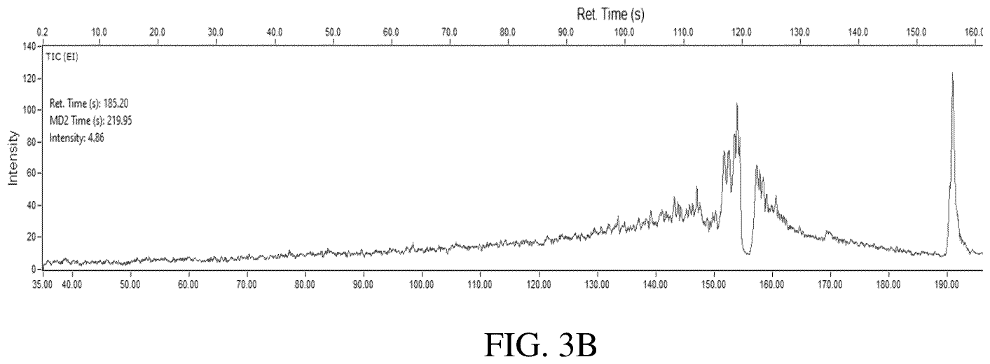

FIG. 3A illustrates results of a Gas Chromatography Mass Spectrometer analysis of a fluid sample with an in-line exhaust that is inactive.

The total ion chromatograph (TIC) detected by an ion trap mass spectrometer (MS) is coupled to a low thermal mass (LTM) gas chromatography (GC) brass board. The LTM-GC is built using a commercially available Rtx-502.2 column (Restek part number: 10256) with a stationary phase thickness of 1-μm. Total GC length comprised of Segment-1 (0.15 m) and Segment-2 (10 m). The hold temperature of segments 1 and 2 is ambient room temperature (23 C). Vapor-phase chemicals sampled are Diethyl methylphosphonate (DEMP; Cas No. 683-08-9) and Methyl salicylate (MeS; Cas No. 119-36-8) using a volatile organic compounds (VOC) preconcentrator upstream of the GC stage. The TIC shows the signal detected without using the in-line exhaust design. The VOC preconcentrator samples the headspace of the DEMP and MeS vials for ten second each. The data is collected with a GC brassboard with manual heating of the first segment to 150° C. using a handheld heat gun while the segment-2 is heated with a well-controlled proportional-integral-derivative controller temperature feedback loop enabled heating bracket embedded in the segment-2.

FIG. 3B illustrates results of a Gas Chromatography Mass Spectrometer analysis of a fluid sample with an in-line exhaust that is active.

The experimental set up for FIG. 3A is similar to and with the in-line exhaust activated. For both DEMP and MeS, a significant increase in the signal is observed. The manual heat-gun heating process on segment-1 is evident from the non-gaussian DEMP peak (at retention time ˜116 seconds), which tends to be a sticky chemical for the stationary phase used (Rtx-502.2; 1-μm thick stationary phase). For MeS peak (retention time 156 seconds), the area under the curve for the two peaks in the two experiments are easily quantifiable and is area under the curve is 5× higher when activating the in-line exhaust during injection.

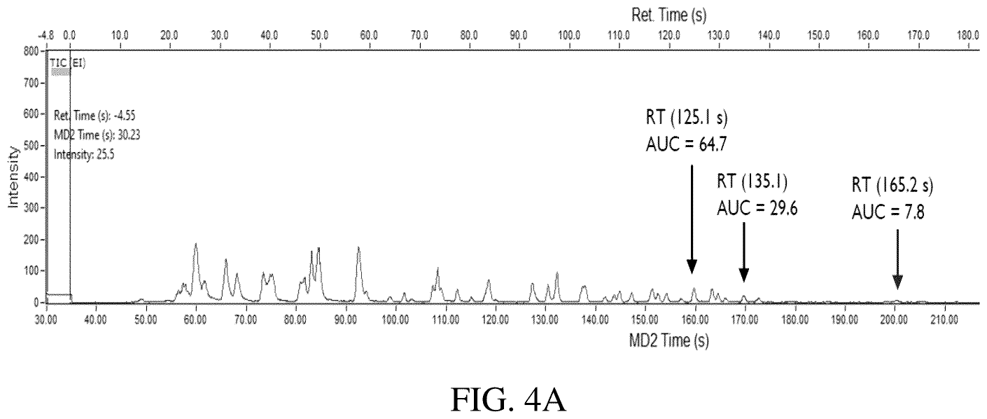

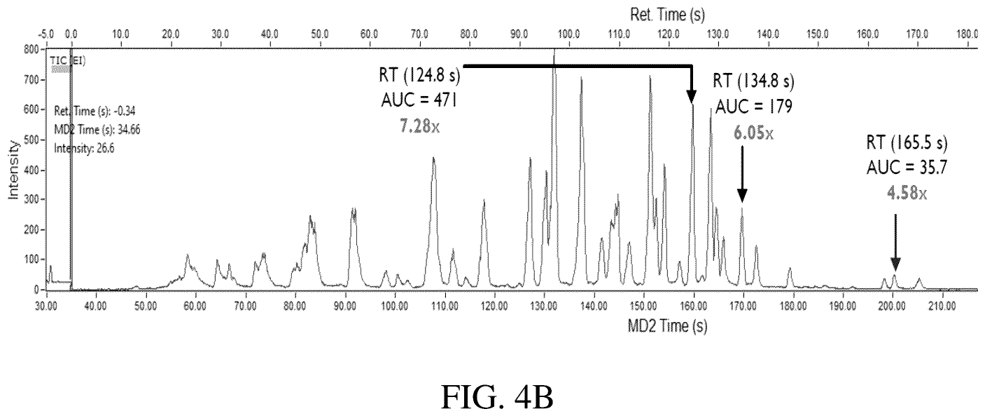

FIG. 4A illustrates results of a Gas Chromatography Mass Spectrometer analysis of a fluid sample with an in-line exhaust that is inactive.

The experimental set up is similar to FIG. 3A with an improved LTM-GC prototype with an embedded heating bracket installed on segment-1. This allowed uniform temperature control across segment-1 and segment-2 of the GC prototype. For this experiment, a 53-VOC component mixture (EPA-624 CALIBRATION Mix-1; Sigma Aldrich part no. 861311) is used without the in-line exhaust activated. The headspace from the EPA-624 vial is sampled for 1 second. After the desorption process, the TIC measured by the MS is shown, with a select VOC peak labeled for AUC comparison with FIG. 4B.

FIG. 4B illustrates results of a Gas Chromatography Mass Spectrometer analysis of a fluid sample with an in-line exhaust that is active.

The experimental setup is similar to FIG. 4 A but with the in-line exhaust activated. The headspace from the EPA-624 vial was sampled for 1 second. The measured TIC shows significant increase in signals detected for the mid to later eluting VOC.s We have shown area under the curve comparison for three select VOC peaks at RTs 125.1, 135.1 and 165.2 seconds.

FIG. 4B illustrates the TIC detected by the MS, for the experimental setup similar to FIG. 4 A but with the in-line exhaust activated. The headspace from the EPA-624 vial is sampled for 1 second. The measured TIC shows significant increase in signals detected for the mid to later eluting VOC including tert-butylbenzene (CAS #98-06-6); RT 134.8s=1,3-dichlorobenzene (CAS #541-73-1) and RT 165.5s=Naphthalene (CAS #91-20-3) of the EPA-624 vial. The results show AUC comparison for three select VOC at RTs 125.1, 135.1 and 165.2 seconds.

What is claimed is:

1. A fluid chromatography device, comprising:
a. a first segment of a column configured to connect with an entry location that is configured to receive a fluid sample;
b. a second segment of the column in fluid communication with the first segment at a connection; and
c. an in-line exhaust in fluid communication with the first segment at the connection between the first and second segments, wherein the in-line exhaust is configured to vent the fluid sample from the first segment until closed;
wherein the in-line exhaust is configured to close after a period of time after a sample is injected into the first segment,
wherein a flow rate of the fluid sample of the first segment before the in-line exhaust closes is higher than a flow rate of the fluid sample of the first and second segments after the in-line exhaust closes.

2. The fluid chromatography device of claim 1, further comprising:
a. a temperature control device configured to lower a temperature of the first segment so that stationary phase in the column is controlled.

3. The fluid chromatography device of claim 1, further comprising:
a. the entry location in fluid communication with the first segment and configured to receive the fluid sample before injection into the first segment.

4. The fluid chromatography device of claim 3, further comprising:
a. an injection exhaust in fluid communication with the entry location and configured to vent the fluid sample as the fluid sample is injected into the first segment so that a flow rate of the fluid sample into the first segment is controlled.

5. The fluid chromatography device of claim 5, wherein the entry location is configured to concentrate the fluid sample before entry into the first segment.

6. The fluid chromatography device of claim 1, further comprising:
a. a third segment in fluid communication with the in-line exhaust, the second segment, and the first segment at the connection.

7. The fluid chromatography device of claim 1, further comprising:
a. a detector in fluid communication with second segment and configured to detect molecules of the fluid sample after the fluid sample has moved through the column.

8. The fluid chromatography device of claim 1, wherein the entry location is configured as an injection port or a pre-concentrator.

9. A fluid chromatography device, comprising:
a. an inlet configured to receive a fluid sample;
b. an outlet connectable with a detector;
c. a column that extends between the inlet and outlet, comprising:
i. a first segment connected with the inlet; and
ii. a second segment that is in fluid communication with the first segment and configured to connect with a detector at the outlet; and
d. an in-line exhaust configured to vent the fluid sample from the first segment until closed, wherein after the in-line exhaust closes, the fluid flow rate of the fluid sample decreases in the column.

10. The fluid chromatography device of claim 9, wherein the fluid sample flows at a first flow rate through the first segment when the in-line exhaust is opened, wherein the fluid sample flow at second flow rate when the in-line exhaust is closed, and wherein the first flow rate is greater than the second flow rate.

11. The fluid chromatography device of claim 10, further comprising:
a. an entry location in fluid communication with the first segment and configured to receive the fluid sample; and
b. an injection exhaust in fluid communication with the first segment and configured to vent the fluid samples so that the first and/or second flow rate is controlled.

12. The fluid chromatography device of claim 1, further comprising:
a. a temperature control device configured to adjust a temperature of the stationary phase of the column.

13. The fluid chromatography device of claim 12, wherein the temperature control device is configured to cool the temperature of the column and control the stationary phase.

14. The fluid chromatography device of claim 1, wherein the detector comprises a mass spectrometer, a flame ionization detector, a photoionization detector, electron capture detector, ion mobility spectrometer, thermal iconic detector, ultraviolet detector, fluorescence detector, thermal conductivity detector, flame photometric detectors, or any combination thereof.

15. A method, comprising:
a. injecting a fluid sample into a first segment of a column that is open to an external environment through an in-line exhaust at a first flow rate;
b. closing the in-line exhaust to change the flow rate of the fluid sample to a second flow rate that is less than the first flow rate; and
c. detecting one or more molecules of the fluid sample after the one or more molecules have moved through the column.

16. The method of claim 15, further comprising:
a. before injecting the fluid sample into the first segment, injecting the sample into an entry location that is in fluid communication with the first segment and an injection exhaust, wherein the injection exhaust is configured to control the first flow rate; and
b. after injecting the fluid sample into the first segment, closing the first segment from the injection port or pre-concentrator.

17. The method of claim 15, further comprising:
a. cooling the first segment before, while, or after injecting the fluid sample into the first segment.

18. The method of claim 15, wherein the first segment and the second segment connect at a connection, and wherein the in-line exhaust connects to the connection through a third segment.

19. The method of claim 18, further comprising:
a. opening the in-line exhaust to vent the fluid sample, after detecting one or more compounds at the detector.

20. The method of claim 15, further comprising:
a. while, before or after opening the in-line exhaust to vent the fluid sample, applying heat to the column.
